(19) United States
(12) Patent Application Publication
(10) Pub. No.: US 2012/0155793 A1
(43) Pub. Date: Jun. 21, 2012

(54) BEARING ARRANGEMENT FOR HIGH-SPEED SHAFTS OF MACHINES

(75) Inventors: Peter SOLFRANK, Frensdorf (DE); Christian SCHAEFER, Nuernberg (DE); Christopher MITCHELL, St. Austell (GB); Heiko SCHMIDT, Muehlhausen (DE); Gerhard GOESS, Herzogenaurach (DE)

(73) Assignee: SCHAEFFLER TECHNOLOGIES GMBH & CO. KG, Herzogenaurach (DE)

(21) Appl. No.: 13/240,698

(22) Filed: Sep. 22, 2011

(30) Foreign Application Priority Data
Dec. 17, 2010 (DE) 10 2010 063 391.7

(51) Int. Cl. F16C 33/66; F16C 19/00

(52) U.S. Cl. 384/475

(57) ABSTRACT

A bearing arrangement for high-speed shafts of machines, such as rotor shafts of turbochargers. The bearing arrangement has a bearing housing that has at least one oil feed line and in the housing at least one bearing is installed. The bearing guides the shaft at least radially. The bearing has a ring with at least one oil bore. The ring forms an annular gap with the bearing housing. The bearing is a single-row rolling contact bearing, in which the shaft is guided directly or via an inner ring, preferably a two-part inner ring, and the ring is an outer ring of the rolling contact bearing.

### CROSS-REFERENCE TO RELATED APPLICATION

This application claims the priority of DE 10 2010 063 391.7 filed Dec. 17, 2010, which is incorporated by reference herein.

### FIELD OF THE INVENTION

The invention relates to a bearing arrangement for high-speed shafts of machines, such as rotor shafts of turbochargers, having a bearing housing, which has at least one oil feed line and in which is installed at least one bearing that guides the shaft of the machine at least radially. The bearing has a ring with at least one oil bore, and the ring forms an annular gap with the bearing housing.

### BACKGROUND OF THE INVENTION

A bearing arrangement of this kind is known from the article entitled “Turbolader: Aufbau and Funktionsweise, Lagerung” [Turbochargers: Construction and Operation, Bearings” by Borg Warner Turbo Systems, published on the Internet at www.turbodriven.com/de/turbofacts/designBearingSystem.aspx. In this bearing arrangement, the rotor shaft of the turbocharger is guided radially by means of plain bearings, with oil being supplied from the internal combustion engine, via the oil feed line, to a floating bush which, for its part, forms an annular gap with respect to the bearing housing. The rotor shaft is supported in the floating bush by means of a bearing gap. The oil in the annular gap and that in the bearing gap are furthermore intended to exercise a damping function. The bearing assembly is designed in such a way that the floating bush corotates and turns at half the speed of the rotor shaft.

The above-mentioned article also describes a plain bearing assembly, which is designed as a single-bush bearing assembly. The rotor shaft rotates within a fixed bush, around the outside of which there is a flow of oil, lubricating the rotor shaft in the bush.

DE 10 2009 008 434 A1 has furthermore disclosed designing the oil feed line in the bearing housing in such a way that it forms a tangent with a floating bush, the direction of rotation of the shaft and of the floating bush being opposed to the oil feed direction. The aim of this measure is to slow the speed of the floating hush, for which purpose also pockets are machined into the surface of the floating bush, these pockets having radially oriented walls, on which the oil feed flow impinges.

### SUMMARY OF THE INVENTION

Starting from the disadvantages explained in the known prior art, it is therefore the underlying object of the invention to simplify and reduce the cost of the bearing assemblies described and to design the circumferential surface of the ring in such a way that it can be produced easily in terms of production engineering and that it allows an optimum supply of oil for lubrication and squeeze oil damping.

According to the invention, this object is achieved by a bearing arrangement for high-speed shafts of machines, such as rotor shafts of turbochargers, which has a bearing housing. The bearing housing has at least one oil feed line and in the housing at least one bearing is installed. The bearing guides the shaft of the machine at least radially, and the bearing has a ring with at least one oil bore and the ring forms an annular gap with the bearing housing. The bearing is designed as a single-row rolling contact bearing, in which the shaft is guided directly or via an inner ring, preferably an inner ring divided into two, and by designing the ring as the outer ring of the rolling contact bearing.

The invention is thus for a rolling contact bearing, preferably having two rows of rolling contact elements, which preferably interact with an inner ring, in particular an inner ring divided into two, with the shaft being supported in the inner ring. The rows of rolling contact elements are preferably guided in two cages, which are fitted into the one-piece outer ring. The outer ring is in operative connection with the bearing housing via an annular gap, and an oil feed line is provided in the bearing housing, preferably opening radially into the annular gap, and at least one oil bore, which is preferably likewise oriented radially, is furthermore provided in the outer ring.

This results in a simple, economical construction of the bearing assembly for a high-speed shaft and, in a further embodiment of the invention, the outer ring is arranged in the bearing housing in such a way as to be secured against rotation, thus providing a clearly defined division between hearing damping in the annular gap and support in the rolling contact bearing.

The security against rotation is preferably accomplished by means of the outer surfaces of the outer ring and the inner surface of the hearing housing and of the annular gap, and a mechanical means of securing against rotation is also proposed. The outer surfaces of the bearing ring preferably perform three functions. Apart from providing security against rotation, the annular gap forms a squeeze oil damper and, at the same time, ensures the oil supply to the rolling contact bearing.

To provide a reliable supply of oil to the rolling contact bearing, the outer ring has turned slot- or groove-shaped recesses of concave cross-section, with the oil bore preferably being arranged in such a way in the region of the grooves that it is in operative connection with the concave cross-section of the groove or turned recess.

In another embodiment of the invention, it is proposed that the groove be designed to be symmetrical with respect to a cross-sectional plane through the bearing, the edge distance of the groove from the edge of the outer ring being greater than or equal to zero. This means that the groove or a plurality of grooves can occupy the entire outer circumferential surface of the outer ring of the rolling contact bearing.

The line sections which describe the cross-section of the groove can be straight or curved. The center line of the oil bore is preferably perpendicular to a surface of the associated line section. However, the center line of the oil bore does not have to be perpendicular to the surface of the associated line section but can also assume a certain angle α.

The special groove embodiment described allows a comparatively large flow cross-section for a good squeeze damper supply, with the oil bore in the concave cross-section of the groove describing a tight cross-section, which acts like an additional orifice. The fact that the center line of the oil bore is arranged offset relative to the center of the cross-sectional area of the associated line section ensures that the groove cross-section which supplies the oil bore can be set independently of the total cross-section of the groove and can be designed as a restrictor.

### BRIEF DESCRIPTION OF THE DRAWINGS

A preferred embodiment of the bearing arrangement designed in accordance with the invention is explained in greater detail below with reference to the attached drawings, in which:

FIG. 1 shows a cross-section through a bearing arrangement for a high-speed shaft; and

FIGS. 2 to 8 show cross-sections of the groove/grooves including the oil bore on an enlarged scale.

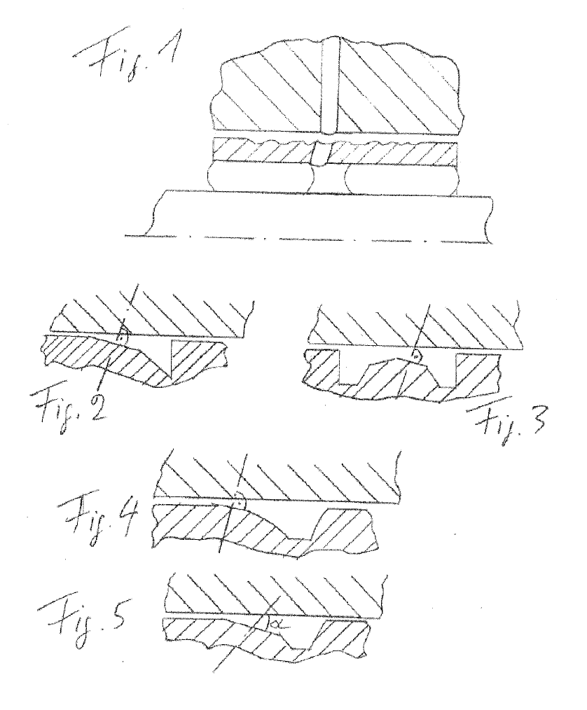

### DETAILED DESCRIPTION OF THE INVENTION

Where components are shown specifically in FIGS. 1 to 8, 1 denotes a bearing housing, into which an oil feed line 2 has been machined. Installed in the bearing housing 1 is an outer ring 3 of a rolling contact bearing, in which rolling contact elements 4 that support a shaft 5 are guided. It should be expressly noted that, as explained in the description and the claims, an inner ring, preferably an inner ring divided into two, can be arranged between the rolling contact elements 4 and the shaft 5, with the result that the shaft 5 then does not roll on the rolling contact elements 4. The outer ring 3 is in operative connection with the bearing housing 1 via an annular gap 6, the annular gap 6 being designed as a squeeze oil damper. The outer ring 3 is guided axially by means of spring lock washers 7, which may also ensure that the outer ring 3 is secured against rotation in the bearing housing 1.

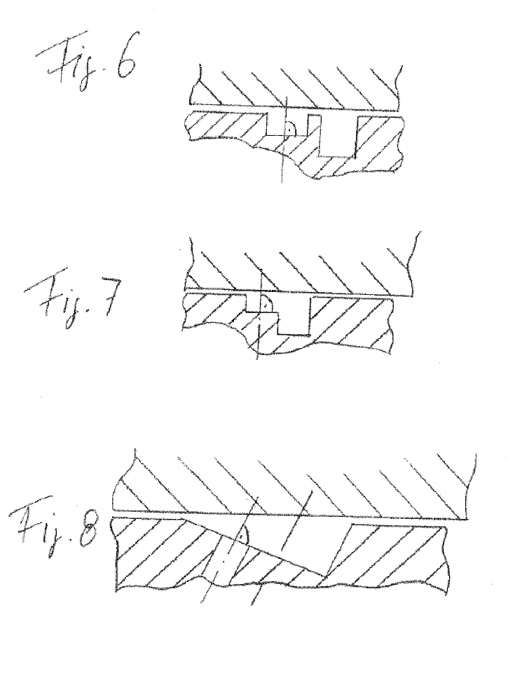

A groove 8 is machined into the outer circumference of the outer ring 3, this groove being ring-shaped and having a concave cross-section. An oil bore 9 is provided in the groove 8, passing through the outer ring 3 and carrying oil to the rolling contact elements 4. As illustrated in FIG. 2, the groove 8 can have a cross-section which forms rectilinear line sections 12 that are oriented radially and obliquely to the axial center line. The center line 10 of the oil bore 9 is oriented perpendicularly to a surface of an associated line section 12.

FIG. 3 shows a groove 8 which is of symmetrical design with respect to a cross-sectional plane through the bearing and consists essentially of two grooves 8 in accordance with FIG. 2, with the transition between the cross-sections and the outer circumference of the outer ring 3 being set back.

The groove 8 shown in FIG. 4 is of shallower design, with two line sections 12 of the cross-section of the groove 8 being curved.

In FIG. 5, the line sections 12 of the cross-section of the groove 8 are of rectilinear design, however the center line 10 of the oil bore 9 is not perpendicular but slopes relative to the line section 12.

In FIG. 6, two grooves 8 are arranged adjacent to one another and have rectangular cross-sections, the oil bore 9 being provided in a groove base and the center line 10 of said groove being perpendicular to the base of the groove 8.

The embodiment shown in FIG. 7 is similar to that in FIG. 6 but the two grooves are combined to give a stepped groove.

The illustrative embodiment shown in FIG. 8 shows a groove 8, the cross-section of which is approximately L-shaped, with the center line 10 of the oil bore 9 being arranged offset outward from the groove base, relative to the center 11 of the line section 12 of the cross-section.

### LIST OF REFERENCE SIGNS

1 Bearing Housing
2 Oil Feed Line
3 Outer Ring
4 Rolling Contact Element
5 Shaft
6 Annular Gap
7 Spring Lock Washers
8 Groove
9 Oil Bore
10 Center Line
11 Center
12 Line Sections

1-10. (canceled)

11. A bearing arrangement for high-speed shafts of machines, comprising:
a bearing housing having at least one oil feed line and at least one single-row rolling contact hearing installed in the bearing housing, the bearing, which can have an inner ring, guiding one of the shafts of the machines at least radially directly or via the inner ring, and the bearing having an outer ring with at least one oil bore, the outer ring forming an annular gap with the hearing housing.

12. The hearing arrangement according to claim 11, wherein the inner ring is a two-part ring.

13. The bearing arrangement according to claim 11, wherein the outer ring is arranged in the bearing housing in such a way as to be secured against rotation.

14. The bearing arrangement according to claim 11, wherein the outer ring has a groove of concave cross-section machined into the outer circumference of the outer ring in a region of the at least one oil bore.

15. The bearing arrangement according to claim 14, wherein the groove is symmetrical with respect to a cross-sectional plane through the bearing, and an edge distance of the groove from an edge of the outer ring being greater than or equal to zero.

16. The bearing arrangement according to claim 14, wherein line sections, which describe the concave cross-section of the groove, are curved.

17. The bearing arrangement according to claim 16, wherein the oil bore has a center line, which is perpendicular to a surface of the line sections.

18. The bearing arrangement according to claim 11, wherein a plurality of grooves are joined together to form a grooved circumferential surface.

19. The bearing arrangement according to claim 18, wherein the grooves of the grooved circumferential surface have cross-sections which are circular segments or trapezoidal or rectangular or square.

20. The bearing arrangement according to claim 17, wherein the center line of the oil bore is arranged offset relative to a center of the line section of the cross-section of the groove.

21. The bearing arrangement according to claim 20, wherein the center line of the oil bore is arranged offset to such an extent that an edge of the oil bore lies outside the line sections of the cross-section of the groove.
